(19) United States
(12) Patent Application Publication
(10) Pub. No.: US 2025/0344297 A1
(43) Pub. Date: Nov. 6, 2025

(54) SIGNAL OUTPUT DEVICE, MICROWAVE OVEN, REFRIGERATOR, AND FREEZER

(71) Applicant: Panasonic Intellectual Property Management Co., Ltd., Osaka (JP)

(72) Inventors: Hidetaka SUGAYA, Shiga (JP); Nobuya Nakade, Osaka (JP); Hikaru Ikeda, Kyoto (JP); Shizuo Fujita, Kyoto (JP); Katsutoshi Fukuda, Kyoto (JP)

(21) Appl. No.: 19/264,263

(22) Filed: Jul. 9, 2025

Related U.S. Application Data
(63) Continuation of application No. PCT/JP2023/043156, filed on Dec. 1, 2023.

(30) Foreign Application Priority Data
Jan. 10, 2023 (JP) 2023-001899

(51) Int. Cl. H05B 6/68; H05B 6/66; H05B 6/72; H05B 6/80

(52) U.S. Cl. CPC H05B 6/687; H05B 6/664; H05B 6/72; H05B 6/80

(57) ABSTRACT

A signal output device outputs an oscillation signal for generating a microwave to irradiate eatables and drinkables. The signal output device includes an oscillator, a phase shifter (e.g., a first phase shifter 40), and a phase control unit. The oscillator outputs the oscillation signal to an antenna that radiates the microwave. The phase shifter is provided at a destination of the oscillator to change load impedance of the antenna as viewed from the oscillator. The phase control unit controls the phase shifter to make the phase shifter change, according to an oscillating frequency of the oscillation signal, the load impedance of the oscillator.

### CROSS-REFERENCE TO RELATED APPLICATIONS

The present application is a Bypass Continuation of International Application No. PCT/JP2023/043156 filed on Dec. 1, 2023, which is based upon and claims the benefit of priority to Japanese Patent Application No. 2023-001899, filed on Jan. 10, 2023, the entire contents of both applications are incorporated herein by reference.

### TECHNICAL FIELD

The present disclosure generally relates to a signal output device, a microwave oven, a refrigerator, and a freezer, and more particularly relates to a signal output device configured to output an oscillation signal for generating a microwave to irradiate eatables and drinkables, and a microwave oven, a refrigerator, and a freezer.

### BACKGROUND ART

A transmitter contributing, even if an isolator is eliminated, to improving the performance of mobile wireless devices has been known in the art (see, for example, JP 09-64758 A, hereinafter referred to as “Patent Literature 1”).

In the transmitter of Patent Literature 1, an output signal of a digital modulator is divided into n signals, which respectively pass through n input phase shifters, each causing a different magnitude of phase shift. Then, the n signals are respectively amplified by n power amplifiers. Thereafter, the n signals are respectively passed through, and combined together by, n output phase shifters to have their phases matched with each other. Finally, the combined and phase-matched signal is output through an output terminal.

In Patent Literature 1, the frequency of the output signal for use in wireless communication is determined in advance. On the other hand, in an electrical device (e.g., a microwave oven) for irradiating eatables and drinkables with a microwave, the frequency of the microwave to radiate is changeable. Therefore, it is difficult to apply the technique of Patent Literature 1 to an electrical device for irradiating eatables and drinkables with a microwave.

### SUMMARY

In view of the foregoing background, it is therefore an object of the present disclosure to provide a signal output device, a microwave oven, a refrigerator, and a freezer, all of which contribute to improving the performance even when eatables and drinkables are irradiated with a microwave.

A signal output device according to an aspect of the present disclosure outputs an oscillation signal for generating a microwave to irradiate eatables and drinkables. The signal output device includes an oscillator, a phase shifter, and a phase control unit. The oscillator outputs the oscillation signal to an antenna that radiates the microwave. The phase shifter is provided at a destination of the oscillator to change load impedance of the antenna as viewed from the oscillator. The phase control unit controls the phase shifter to make the phase shifter change, according to an oscillating frequency of the oscillation signal, the load impedance of the oscillator.

A microwave oven according to another aspect of the present disclosure includes the signal output device described above and a storage container. The storage container stores an object serving as a target to be irradiated with the microwave that is radiated from the signal output device via the antenna.

A refrigerator according to still another aspect of the present disclosure includes the signal output device described above and a storage container. The storage container stores an object serving as a target to be irradiated with the microwave that is radiated from the signal output device via the antenna.

A freezer according to yet another aspect of the present disclosure includes the signal output device described above and a storage container. The storage container stores an object serving as a target to be irradiated with the microwave that is radiated from the signal output device via the antenna.

### BRIEF DESCRIPTION OF THE DRAWINGS

The figures depict one or more implementation in accordance with the present teaching, by way of example only, not by way of limitations. In the figures, like reference numerals refer to the same or similar elements, where:

FIG. 1 is a block diagram illustrating a configuration for a signal output device according to a first embodiment;

FIG. 2 is a block diagram illustrating a configuration for an electrical device including the signal output device;

FIG. 3 is a Smith chart illustrating the impedance characteristics of an antenna;

FIG. 4A is a Smith chart illustrating the load impedance characteristics of the frequency of an oscillation signal output by the signal output device;

FIG. 4B is a Smith chart illustrating the load impedance characteristics of the output power of an oscillation signal output by the signal output device;

FIG. 5A is a Smith chart illustrating the load impedance characteristics of the frequency of an oscillation signal output by a signal output device according to a comparative example;

FIG. 5B is a Smith chart illustrating the load impedance characteristics of the output power of an oscillation signal output by the signal output device according to the comparative example; and

FIG. 6 is a block diagram illustrating a configuration for a signal output device according to a second embodiment.

### DETAILED DESCRIPTION

Note that the embodiments and their variations to be described below are only exemplary ones of various embodiments of the present disclosure and their variations and should not be construed as limiting. Rather, the exemplary embodiments and their variations may be readily modified in various manners depending on a design choice or any other factor without departing from the scope of the present disclosure.

### First embodiment)

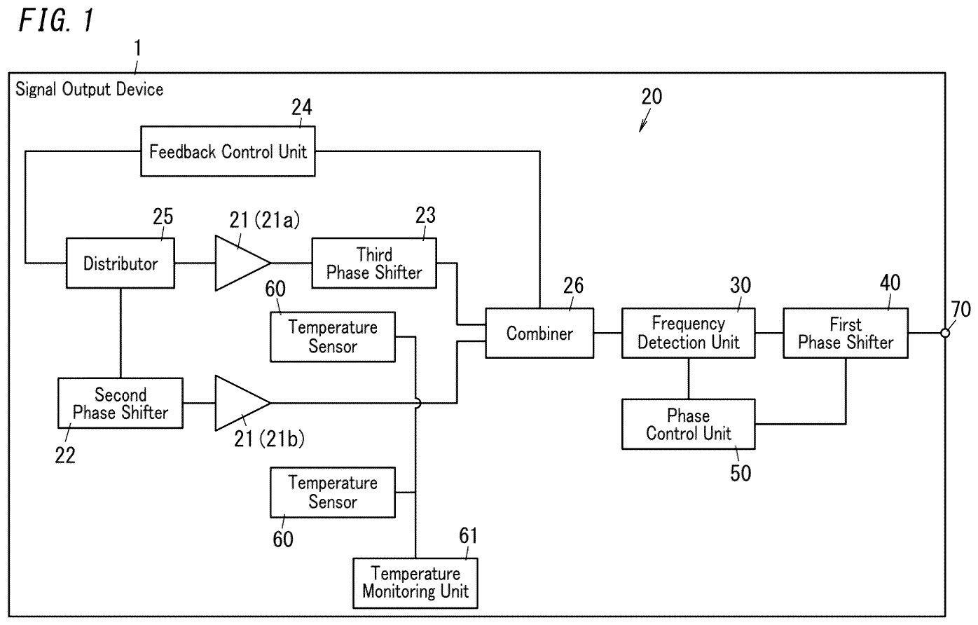

A signal output device 1 and an electrical device 2 according to a first embodiment will now be described with reference to FIGS. 1-5B.

### (1) Overview

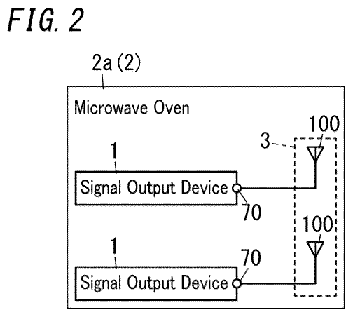

The signal output device 1 according to the first embodiment is designed to irradiate a target of irradiation such as eatables and drinkables with a high-power microwave. The signal output device 1 is applied, for example, to an electrical device 2. In this example, the electrical device 2 is a microwave oven, a refrigerator, or a freezer. FIG. 2 shows a situation where the signal output device 1 is applied to a microwave oven 2a as an exemplary electrical device 2. When applied to the microwave oven 2a, the signal output device 1 heats eatables and drinkables with a high-power microwave.

The signal output device 1 according to the first embodiment outputs an oscillation signal for generating a microwave to irradiate eatables and drinkables. The signal output device 1 outputs the oscillation signal to an antenna 100 (refer to FIG. 2) which is electrically connected to the signal output device 1, and then radiates, via the antenna 100, a microwave corresponding to the oscillation signal. The signal output device 1 includes, as shown in FIG. 1, an oscillator 20, a first phase shifter 40 (phase shifter), and a phase control unit 50. The oscillator 20 outputs the oscillation signal to the antenna 100 (refer to FIG. 2) that radiates the microwave. The first phase shifter 40 is provided at the destination of the oscillator 20 to change the load impedance of the antenna 100 as viewed from the oscillator 20. The phase control unit 50 controls the first phase shifter 40 to have the first phase shifter 40 change the load impedance of the oscillator 20. More specifically, the phase control unit 50 controls the first phase shifter 40 to make the first phase shifter 40 change, according to the oscillating frequency of the oscillation signal, the load impedance of the oscillator 20.

This configuration allows for radiating an appropriate microwave according to the frequency of the oscillation signal. Therefore, this configuration contributes to improving the performance even when eatables and drinkables are irradiated with a microwave.

### (2) Configuration

A configuration for an electrical device 2 and signal output device 1 according to the first embodiment will now be described.

The electrical device 2 includes, as shown in FIG. 2, a signal output device 1 and a storage container 3. The storage container 3 stores an object (eatables and drinkables) serving as a target to be irradiated with a microwave that is radiated from the signal output device 1 via an antenna 100.

The electrical device 2 according to the first embodiment includes, as shown in FIG. 2, one or more (e.g., two in the example illustrated in FIG. 2) signal output devices 1 and a plurality of (e.g., two in the example illustrated in FIG. 2) antennas 100. The one or more antennas 100 are respectively associated one to one with the one or more signal output devices 1. The electrical device 2 includes the storage container 3. The storage container 3 stores the object (eatables and drinkables) serving as the target to be irradiated with the microwave that is radiated from the signal output device(s) 1 via the antenna(s) 100. Each of the antennas 100 is provided for the storage container 3.

If the electrical device 2 is a microwave oven 2a, the one or more signal output devices 1 heat a target of irradiation (e.g., eatables and drinkables) stored in the storage container 3 by irradiating the target of irradiation, with the microwave via the antenna(s) 100.

Note that if the electrical device 2 is a refrigerator, the one or more signal output devices 1 turn the object (eatables and drinkables), kept in the refrigerator, into a ripen state by irradiating the object with the microwave via the antenna(s) 100. Also, the one or more signal output devices 1 turn the object (eatables and drinkables) refrigerated below the ice point into an overcooled state by irradiating the object with the microwave via the antenna(s) 100. As used herein, the “overcooled state” means that a liquid such as water is cooled, without freezing, to a temperature lower than the freezing point (the temperature at which the liquid freezes and turns into a solid). For example, water will freeze at a temperature equal to or lower than zero degrees by nature. However, in the overcooled state, if certain conditions are satisfied, for example, the water does not freeze even at such a temperature equal to or lower than zero degrees and is kept cooled without freezing.

Also, if the electrical device 2 is a freezer, the one or more signal output devices 1 instantaneously freeze, by stopping radiating the microwave, an object (eatables and drinkables), which has been refrigerated below the ice point, i.e., has been kept in the overcooled state, with the microwave via the antenna(s) 100.

Each of the one or more signal output devices 1 (hereinafter simply referred to as the “signal output device 1”) according to the first embodiment generates an oscillation signal, outputs the oscillation signal to an associated one of the one or more antennas 100 (hereinafter simply referred to as the “antenna 100”), and then radiates a microwave corresponding to the oscillation signal via the antenna 100. The antenna 100 radiates the microwave corresponding to the oscillation signal.

Note that this embodiment has a configuration in which the one or more signal output devices 1 are associated one to one with the one or more antennas 100. However, this should not be construed as limiting. Alternatively, a configuration in which some or all of the outputs of the plurality of signal output devices 1 are combined together to be connected to the antennas 100 that are smaller in number than the signal output devices 1 may also be adopted. Still alternatively, a configuration in which the output(s) of the one or more signal output devices 1 are distributed and connected to the antennas 100 that are larger in number than the signal output devices 1 may also be adopted. Yet alternatively, a configuration in which a switch is provided at a contact point between each of the signal output devices 1 and a corresponding one of the antennas 100 to make the antenna, to which any one of the signal output devices 1 is connected, selectable may also be adopted.

Also, as described above, the antenna 100 does not have to be provided. Alternatively, a configuration in which the oscillation signal is output to a waveguide to transmit a microwave such that the microwave is output to the storage container 3 through the waveguide may also be adopted.

The signal output device 1 according to the first embodiment includes, as shown in FIG. 1, an oscillator 20, a frequency detection unit 30, a first phase shifter 40, and a phase control unit 50. The signal output device 1 further includes a plurality of (e.g., two in the example illustrated in FIG. 1) temperature sensors 60, a temperature monitoring unit 61, and an output terminal 70 that is electrically connected to the antenna 100.

The oscillator 20 includes, as shown in FIG. 1, a plurality of (e.g., two in the example illustrated in FIG. 1) amplifiers 21, a second phase shifter 22, a third phase shifter 23, a feedback control unit 24, a distributor 25, and a combiner 26. That is to say, the oscillator 20 is a feedback oscillator and outputs an oscillation signal.

The plurality of amplifiers 21 are connected in parallel. The plurality of amplifiers 21 amplifies the oscillation signal and outputs the oscillation signal thus amplified to the antenna 100 electrically connected to the amplifiers 21. Note that if the plurality of amplifiers 21 need to be distinguished from each other, the plurality of amplifiers 21 will be designated by the reference signs 21a, 21b, and so on.

The second phase shifter 22 is electrically connected to the input terminal of the amplifier 21b. Specifically, one end of the second phase shifter 22 is electrically connected to one of the distributed output terminals of the distributor 25. The other end of the second phase shifter 22 is electrically connected to the input terminal of the amplifier 21b. The second phase shifter 22 shifts the phase of the oscillation signal supplied to the amplifier 21b. Therefore, the amplifier 21b receives a feedback signal, of which the phase has been shifted.

The third phase shifter 23 is electrically connected to the output terminal of the amplifier 21a. Specifically, one end of the third phase shifter 23 is electrically connected to the output terminal of the amplifier 21a. The other end of the third phase shifter 23 is electrically connected to one of the input terminals at one end of the combiner 26 and the output terminal of the amplifier 21b. The third phase shifter 23 shifts the phase of the oscillation signal output by the amplifier 21a

In this circuit configuration, the magnitude of shift caused by the second phase shifter 22 to the phase of the feedback signal is equal to the magnitude of shift caused by the third phase shifter 23 to the phase of the feedback signal.

The combiner 26 generates an oscillation signal by combining together the feedback signal output by the amplifier 21b and the feedback signal of which the phase has been shifted by the third phase shifter 23 and outputs the oscillation signal thus generated to the frequency detection unit 30. The combiner 26 further generates a feedback signal by extracting a part of the oscillation signal thus combined and outputs the feedback signal thus generated to the feedback control unit 24. That is to say, the oscillator 20 makes the plurality of the amplifiers 21 pass the feedback signals having mutually different phases. Then, the oscillator 20 combines together the feedback signals that have respectively passed through the plurality of amplifiers 21 to output the oscillation signal.

The amplifier 21a receives the feedback signal, of which the phase has not been shifted. The amplifier 21a amplifies the feedback signal thus received to output the feedback signal thus amplified. The third phase shifter 23 receives the feedback signal output by the amplifier 21a. The third phase shifter 23 shifts the phase of the feedback signal thus received. The amplifier 21b receives the feedback signal, of which the phase has been shifted by the second phase shifter 22. The amplifier 21b amplifies the feedback signal (i.e., feedback signal of which the phase has been shifted) thus received from the second phase shifter 22 to output the feedback signal that has been amplified. That is to say, the phase of the feedback signal input to and output from the amplifier 21a and the phase of the feedback signal input to and output from the amplifier 21b are different. Meanwhile, the magnitude of shift caused by the second phase shifter 22 to the phase of the feedback signal is equal to the magnitude of shift caused by the third phase shifter 23 to the phase of the feedback signal. Therefore, the phase of the feedback signal output by the amplifier 21b matches the phase of the feedback signal that has been shifted by the third phase shifter 23.

The feedback control unit 24 performs feedback control by making the combiner 26 extract a part of the oscillation signal generated by combining together the feedback signal amplified by the amplifier 21a and the feedback signal amplified by the amplifier 21b. Specifically, the feedback control unit 24 performs frequency control to control the frequency and phase of the microwave to radiate toward their respective target values. The feedback control unit 24 outputs the feedback signal to the plurality of amplifiers 21 by performing the feedback control on the plurality of amplifiers 21.

The distributor 25 distributes the feedback signal, output by the feedback control unit 24, to the amplifier 21a and the second phase shifter 22.

The combiner 26 of the oscillator 20 outputs the oscillation signal, generated by combining together the feedback signal amplified by the amplifier 21a and the feedback signal amplified by the amplifier 21b, to the frequency detection unit 30. The combiner 26 further generates the feedback signal by extracting a part of the oscillation signal thus combined and outputs the feedback signal thus generated to the feedback control unit 24.

The frequency detection unit 30 detects the frequency of the oscillation signal output by the oscillator 20. That is to say, the frequency detection unit 30 detects the frequency of the oscillation signal thus combined. The frequency detection unit 30 outputs the result of detection (i.e., the frequency of the oscillation signal thus combined) to the phase control unit 50. The frequency detection unit 30 further outputs the oscillation signal thus combined to the first phase shifter 40.

The phase control unit 50 controls the first phase shifter 40 to make the first phase shifter 40 change the load impedance of the oscillator 20. That is to say, the phase control unit 50 controls the first phase shifter 40 to make the first phase shifter 40 change the load impedance of the oscillator 20 according to the oscillating frequency of the oscillation signal. Specifically, the phase control unit 50 controls the first phase shifter 40 to make the first phase shifter 40 shift the phase of the oscillation signal according to the frequency of the oscillation signal detected by the frequency detection unit 30. The phase control unit 50 makes the first phase shifter 40 modulate, based on the frequency detected by the frequency detection unit 30, the frequency of the oscillation signal. The impedance characteristics of an antenna varies according to the frequency of a microwave radiated. The phase control unit 50 makes the first phase shifter 40 modulate, based on the frequency detected by the frequency detection unit 30, the frequency of the oscillation signal to allow the impedance of the antenna to fall within an appropriate range. That is to say, the phase control unit 50 shifts, based on the frequency detected by the frequency detection unit 30, the phase of the oscillation signal by controlling the first phase shifter 40 to allow the impedance of the antenna to fall within the appropriate range.

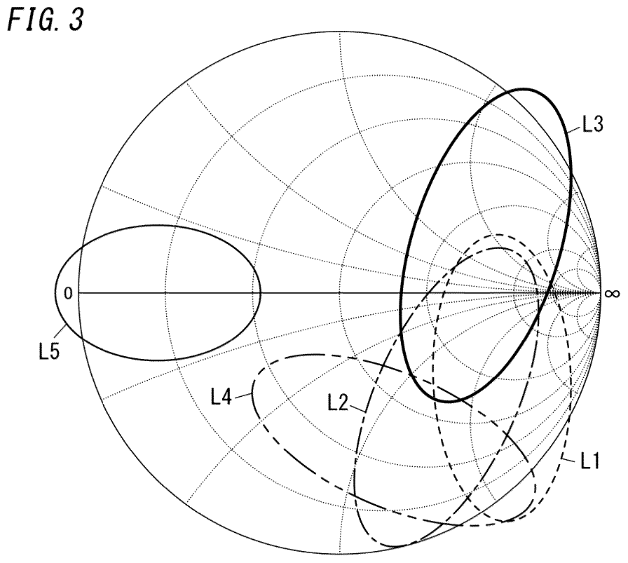

In a situation where a plurality of eatables and drinkables are stored in the storage container 3, the impedance of the antenna falls, according to the frequency, within a certain range in a Smith chart. FIG. 3 illustrates, for example, the impedance characteristics of an antenna in a situation where the frequency is 2.4 GHZ-2.5 GHZ. The range L1 shown in FIG. 3 is a range in which the impedance of the antenna falls in a situation where a signal with a frequency of 2.4 GHz is output. The range L2 shown in FIG. 3 is a range in which the impedance of the antenna falls in a situation where a signal with a frequency of 2.43 GHz is output. The range L3 shown in FIG. 3 is a range in which the impedance of the antenna falls in a situation where a signal with a frequency of 2.45 GHz is output. The range L4 shown in FIG. 3 is a range in which the impedance of the antenna falls in a situation where a signal with a frequency of 2.47 GHz is output. The range L5 shown in FIG. 3 is a range in which the impedance of the antenna falls in a situation where a signal with a frequency of 2.5 GHz is output. As can be seen, the impedance characteristics of an antenna vary according to the frequency of a microwave radiated. Therefore, as described above, the phase control unit 50 makes the first phase shifter 40 modulate, based on the frequency of the oscillation signal, the frequency of the oscillation signal to allow the impedance of the antenna to fall within an appropriate range. This allows for radiating an appropriate microwave according to the frequency of the oscillation signal.

For example, the phase control unit 50 determines, by reference to a table in which magnitudes of phase shift, associated one to one with a plurality of frequencies, are stored in advance, the magnitude of phase shift according to the frequency of the oscillation signal detected by the frequency detection unit 30. The phase control unit 50 shifts, based on the magnitude of phase shift thus determined, the phase of the oscillation signal by controlling the first phase shifter 40.

The first phase shifter 40 is provided at the destination of the oscillator 20 to change the load impedance of the antenna 100 as viewed from the oscillator 20. Specifically, the first phase shifter 40 changes, under the control of the phase control unit 50, the load impedance of the antenna 100 as viewed from the oscillator 20 according to the frequency detected by the frequency detection unit 30 to allow the impedance of the antenna 100 to fall within an appropriate range. The first phase shifter 40 is electrically connected to the output terminal 70. The oscillation signal, which has passed through the first phase shifter 40, is radiated as a microwave via the antenna 100 that is electrically connected to the output terminal 70.

The plurality of temperature sensors 60 respectively detect the temperatures of the plurality of amplifiers 21. The plurality of temperature sensors 60 are associated one to one with the plurality of amplifiers 21, and each detect the temperature of associated one of the plurality of amplifier 21. Each of the plurality of temperature sensors 60 outputs the result of detection with respect to an associated one of the plurality of amplifiers 21 (i.e., the temperature of the associated one of the amplifiers 21) to the temperature monitoring unit 61.

The temperature monitoring unit 61 receives the result of detection from each of the plurality of temperature sensors 60. The function of generating the oscillation signal using the oscillator 20 is controlled based on each of the results of detection that the temperature monitoring unit 61 has received. For example, at least one of the frequency control, phase control, or amplitude control of the oscillation signal is controlled based on the plurality of results of detection that the temperature monitoring unit 61 has received. Specifically, in a situation where all of the plurality of detected temperatures are equal to or higher than a first threshold value, the oscillator 20 is controlled to stop radiating microwaves. In a situation where at least one of the plurality of detected temperatures is lower than the first threshold value and equal to or higher than a second threshold value, at least one of the frequency control, phase control, or amplitude control of the microwave to radiate is controlled. In a situation where, for example, the frequency control is performed, the oscillator 20 is controlled to change the frequency of the microwave from a first frequency to a second frequency. As used herein, the second frequency is lower than the first frequency. In a situation where the phase control is performed, the phase of the microwave radiated is synchronized, e.g., by injection locking, with that of an external reference signal. Also, in a situation where the amplitude control is performed, the supply voltage is controlled to reduce the amplitude of the microwave radiated. In a situation where all of the plurality of detected temperatures are lower than the second threshold value, control on the oscillator 20 is not performed.

Note that the control based on the result of detection obtained by the temperature sensors 60 may also be performed by the signal output device 1, the feedback control unit 24, or an external device.

The output terminal 70 is provided between the first phase shifter 40 and the antenna 100. The output terminal 70 is electrically connected to each of the first phase shifter 40 and the antenna 100. The output terminal 70 outputs the oscillation signal (i.e., the microwave), supplied from the first phase shifter 40, to the antenna 100.

### (3) Operation

Next, an exemplary operation of the signal output device 1 will be described.

The oscillator 20 makes a plurality of amplifiers 21 pass a plurality of feedback signals having mutually different phases. Then, the oscillator 20 combines together the feedback signals that have respectively passed through the plurality of amplifiers 21 to generate an oscillation signal.

The frequency detection unit 30 detects the frequency of the oscillation signal output by the oscillator 20. The phase control unit 50 makes the first phase shifter 40 modulate, based on the frequency detected by the frequency detection unit 30, the frequency of the oscillation signal to allow the impedance of an antenna to fall within an appropriate range. The first phase shifter 40 shifts the phase of the oscillation signal under the control of the phase control unit 50.

The oscillation signal, of which the phase has been shifted by the first phase shifter 40, is radiated, inside the storage container 3, as a microwave from the antenna 100.

Also, the antenna 100 receives a reflected wave of the microwave radiated. The reflected wave is received and a reflection signal representing the reflected wave thus received is supplied to each of the plurality of amplifiers 21. This causes an increase in the temperature of each of the plurality of amplifiers 21. Thus, each of the plurality of temperature sensors 60 detects the temperature of its associated amplifier 21, and the temperature monitoring unit 61 monitors the result thus obtained.

Even if there are no reflected waves, each of the plurality of temperature sensors 60 also detects the temperature of its associated amplifier 21 in a situation where the temperature of the signal output device 1 has increased due to, for example, a decline in the cooling performance of a cooling mechanism of the signal output device 1. The temperature monitoring unit 61 monitors the result thus obtained.

The function of generating the oscillation signal using the oscillator 20 is controlled based on each of the temperatures of the plurality of amplifiers 21 monitored by the temperature monitoring unit 61, i.e., the result of detection (i.e., the detected temperature) obtained by an associated one of the temperature sensors 60.

### (4) Advantages

As can be seen from the foregoing description, a signal output device 1 according to the first embodiment outputs an oscillation signal for generating a microwave to irradiate eatables and drinkables. The signal output device 1 includes an oscillator 20 that generates the oscillation signal, a phase shifter (i.e., a first phase shifter 40), and a phase control unit 50. The oscillator 20 outputs the oscillation signal to an antenna that radiates the microwave. The phase shifter is provided at the destination of the oscillator 20 to change the load impedance of an antenna 100 as viewed from the oscillator 20. The phase control unit 50 makes the phase shifter control, according to an oscillating frequency of the oscillation signal, the load impedance of the oscillator 20.

This configuration allows for radiating an appropriate microwave according to the frequency of the oscillation signal. Therefore, this configuration contributes to improving the performance even when eatables and drinkables are irradiated with a microwave.

Also, in the signal output device 1, the oscillator 20 includes: a plurality of amplifiers 21 connected in parallel; and a feedback control unit 24 for performing feedback control on the oscillator 20. The oscillator 20 makes the plurality of amplifiers 21 pass oscillation signals having mutually different phases. Then, the oscillator 20 combines together the feedback signals that have respectively passed through the plurality of amplifiers 21 to generate an oscillation signal.

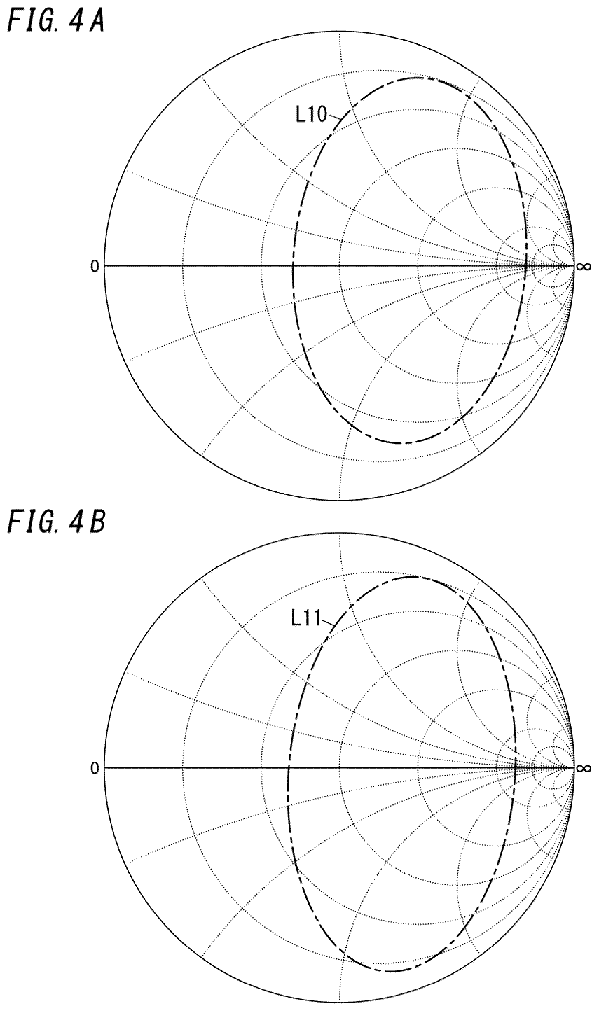

FIG. 4A shows the load characteristics of the frequency of the oscillation signal in a situation where the destination (e.g., the inside of the storage container 3) of the antenna 100 is viewed from the plurality of amplifiers 21 in the signal output device 1. FIG. 4B shows the load characteristics of the output power in a situation where the destination (e.g., the inside of the storage container 3) of the antenna 100 is viewed from the plurality of amplifiers 21 in the signal output device 1. That is to say, FIGS. 4A and 4B respectively show the load characteristics of the frequency and the load characteristics of the output power in a situation where the destination of the antenna 100 is viewed from the plurality of amplifiers 21 in the signal output device 1 when the plurality of amplifiers 21 pass oscillation signals having mutually different phases. The range L10 shown in FIG. 4A is a range of the oscillating frequency available with respect to the impedance of the load characteristics in a situation where the destination of the antenna 100 is viewed from the oscillator 20 in the signal output device 1 when the plurality of amplifiers 21 respectively pass the oscillation signals having mutually different phases. The range L11 shown in FIG. 4B is a range of the output power available with respect to the impedance of the load characteristics in a situation where the destination of the antenna 100 is viewed from the oscillator 20 in the signal output device 1 when the plurality of amplifiers 21 respectively pass feedback signals having mutually different phases.

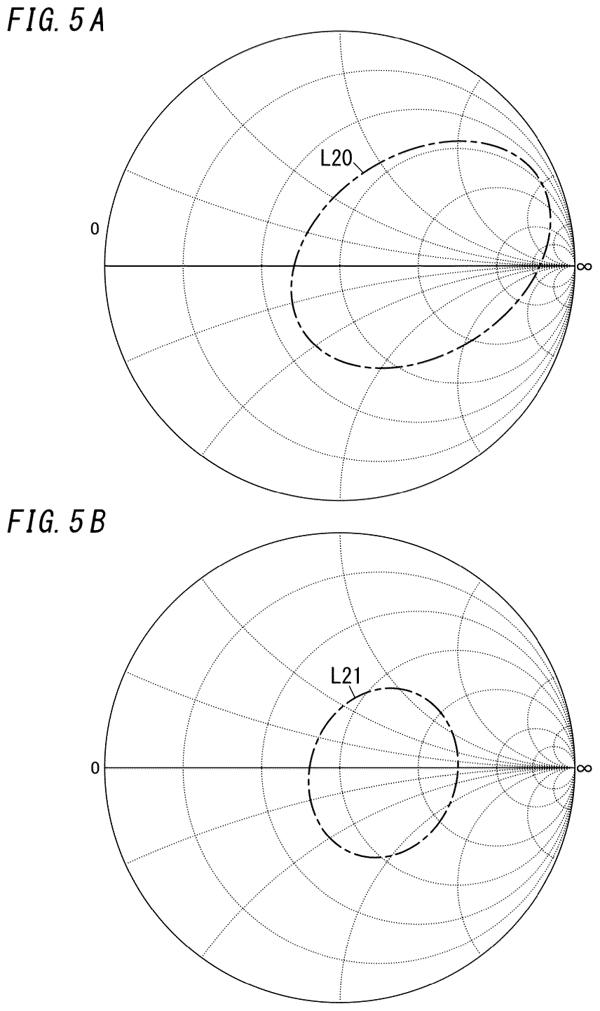

Also, the range L20 shown in FIG. 5A is a range of the oscillating frequency available with respect to the impedance of the load characteristics in a situation where in a signal output device (hereinafter referred to as a signal output device according to a comparative example) including a plurality of amplifiers connected in parallel, the plurality of amplifiers respectively pass oscillation signals having the same phase. The range L21 shown in FIG. 5B is a range of the output power available with respect to the impedance of the load characteristics in a situation where the plurality of the amplifiers respectively pass the oscillation signals having the same phase in the signal output device according to the comparative example.

As can be seen from FIGS. 4A and 5A, the range L10 representing the load characteristics corresponding to the oscillating frequency available for the oscillator 20 in the signal output device 1 is broader than the range L20 representing the load characteristics corresponding to the oscillating frequency available for the oscillator 20 in the signal output device according to the comparative example. In the same way, as can be seen in FIGS. 4B and 5B, the range L11 representing the load characteristics corresponding to the output power available for the oscillator 20 in the signal output device 1 is broader than the range L21 representing the load characteristics corresponding to the output power available for the oscillator 20 in the signal output device according to the comparative example.

Therefore, making the plurality of amplifiers 21 pass such oscillation signals having mutually different phases allows for broadening the range of the impedance of the load characteristics corresponding to the oscillating frequency available and the range of the impedance of the load characteristics corresponding to the output power available.

### (5) Variations

Next, variations will be enumerated one after another. Note that the variations to be described below may be adopted as appropriate in combination with the first embodiment.

### (5.1) First Variation

In the first embodiment, the antenna 100 is not one of the constituent elements of the signal output device 1. However, this should not be construed as limiting. Alternatively, the signal output device 1 may also include the antenna 100 as a constituent element thereof.

### (5.2) Second Variation

In the first embodiment, the oscillator 20 has a configuration in which the plurality of amplifiers 21 are connected in parallel. However, this is not the only configuration.

Alternatively, the oscillator 20 may also include only one amplifier 21 as one of its constitute elements. In that case, the signal output device 1 includes only one temperature sensor 60. The temperature sensor 60 detects the temperature of the one amplifier 21 included in the oscillator 20. Also, the frequency detection unit 30 detects the frequency of the oscillation signal output by the oscillator 20 including the one amplifier 21. The phase control unit 50 controls the first phase shifter 40 to make the first phase shifter 40 shift the phase of the oscillation signal according to the frequency thus detected.

### (5.3) Third Variation

The oscillator 20 may also have a configuration in which the distributor 25 for distributing the feedback signal to the plurality of amplifiers 21 is in charge of a part or all of the magnitude of phase shift to be caused by the second phase shifter 22. In addition, the oscillator 20 may also have a configuration in which the combiner 26 for combining together the output signals of the plurality of amplifiers 21 is in charge of a part or all of the magnitude of phase shift to be caused by the third phase shifter 23.

### (5.4) Fourth Variation

In the first embodiment, the oscillator 20 has a configuration in which the plurality of amplifiers 21 are made to pass oscillation signals having mutually different phases. However, this should not be construed as limiting. Alternatively, the oscillator 20 may also make at least two of the plurality of amplifiers 21 pass oscillation signals having mutually different phases.

### (5.5) Fifth Variation

In the first embodiment, the first phase shifter 40 changes the load impedance of the antenna 100 as viewed from the oscillator 20. However, this should not be construed as limiting. Alternatively, the first phase shifter 40 may change not only the phase but also the impedance.

### Second Embodiment

In a second embodiment, the oscillator thereof is an amplifier-type oscillator. This is a difference from the first embodiment in which the oscillator thereof is a feedback oscillator.

Next, a configuration of a signal output device 1A according to the second embodiment will be described. The following description will be focused on differences from the first embodiment. Note that any constituent element of the second embodiment, having the same configuration as a counterpart of the first embodiment, will be designated by the same reference numeral as that counterpart's, and description thereof will be omitted as appropriate herein.

The signal output device 1A according to the second embodiment is, as in the first embodiment, applied to an electrical device 2. In this case, the electrical device 2 to which the signal output device 1A is applied may be, for example, a microwave oven, a refrigerator, or a freezer. That is to say, the electrical device 2 according to the second embodiment includes the signal output device 1A and the storage container 3.

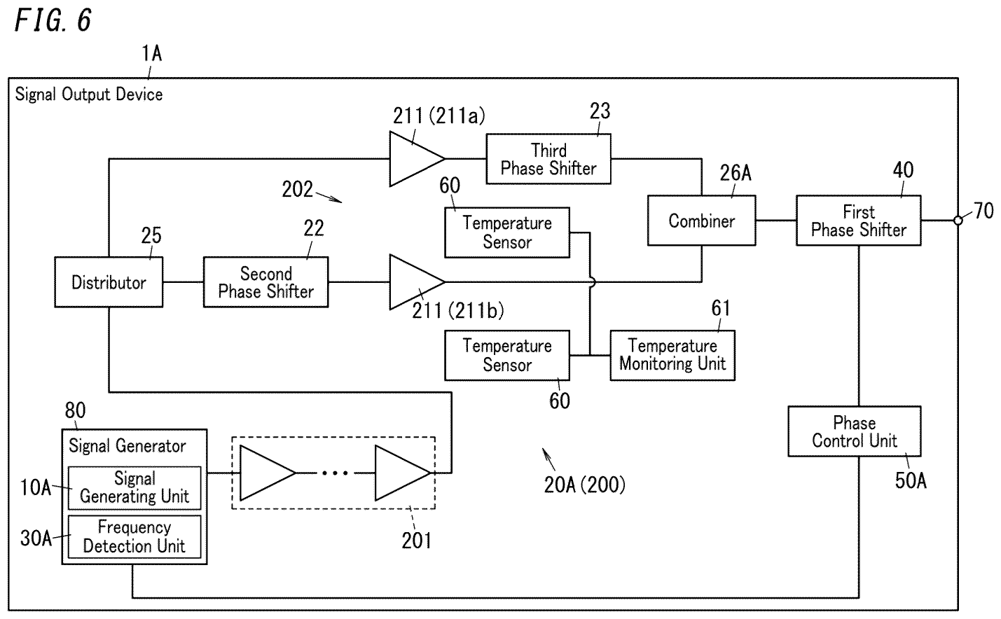

The signal output device 1A according to the second embodiment includes, as shown in FIG. 6, a signal generator 80, an oscillator 20A, the first phase shifter 40, and a phase control unit 50A. The signal output device 1A further includes the plurality of (e.g., two in the example illustrated in FIG. 6) temperature sensors 60, the temperature monitoring unit 61, and the output terminal 70 that is electrically connected to the antenna 100 (refer to FIG. 2).

The signal generator 80 includes a signal generating unit 10A and a frequency detection unit 30A.

The signal generating unit 10A is a semiconductor microwave oscillator and controls the frequency to generate (i.e., oscillate) an oscillation signal that will form the basis of a microwave with a predetermined frequency. The signal generating unit 10A performs phase control. The signal generating unit 10A includes, for example, a quadrature modulation circuit and shifts the phase of the oscillation signal. The signal output device 1A further performs gain control, i.e., amplitude control of the oscillation signal. The signal generating unit 10A performs gain adjustment on the oscillation signal.

The frequency detection unit 30A detects the frequency of the oscillation signal generated by the signal generating unit 10A.

The oscillator 20A includes, for example, a power amplifier 200.

The power amplifier 200 amplifies the oscillation signal and outputs the oscillation signal thus amplified to the antenna 100 electrically connected to the power amplifier 200. The power amplifier 200 includes a device group 201 made up of a plurality of devices, a device 202 on the last stage, the distributor 25, and a combiner 26A. The plurality of devices included in the device group 201 and the device 202 on the last stage are, for example, transistors. The device 202 will be hereinafter sometimes referred to as the “last-stage device 202.” The oscillator 20A (i.e., the power amplifier 200) according to the second embodiment includes the plurality of devices included in the device group 201 and the last-stage device 202. That is to say, the oscillator 20A is a so-called “amplifier-type oscillator” for amplifying, through the amplifier, the oscillation signal generated by the signal generator 80.

The device group 201 is electrically connected to the signal generating unit 10A. The device group 201 is electrically connected to the last-stage device 202. The distributor 25 distributes the oscillation signal, output by the device group 201, to the amplifier 211a and the second phase shifter 22. The last-stage device 202 is electrically connected to the output terminal 70. That is to say, the last-stage device 202 is electrically connected to the antenna 100. The last-stage device 202 outputs, via the output terminal 70, the oscillation signal (i.e., a microwave) to the antenna 100.

The last-stage device 202 includes, as shown in FIG. 6, a plurality of (e.g., two in the example illustrated in FIG. 6) amplifiers 211 connected in parallel. Note that if the plurality of amplifiers 211 need to be distinguished from each other, the plurality of amplifiers 211 will be hereinafter designated by the reference signs 211a, 211b, and so on.

The combiner 26A of the oscillator 20A (i.e., the power amplifier 200) combines together the oscillation signal output by the amplifier 211b and the oscillation signal, of which the phase has been shifted by the third phase shifter 23. Specifically, two oscillation signals having mutually different phases are passed through the plurality of amplifiers 211, respectively. Then, the combiner 26A combines together the oscillation signals that have respectively passed through the plurality of amplifiers 211.

The amplifier 211a receives the oscillation signal, of which the phase has not been shifted. The amplifier 211a amplifies the oscillation signal thus received to output an oscillation signal thus amplified. The third phase shifter 23 receives the oscillation signal output by the amplifier 211a. The third phase shifter 23 shifts the phase of the oscillation signal thus received. The amplifier 21b receives the oscillation signal, of which the phase has been shifted by the second phase shifter 22. The amplifier 211b amplifies the oscillation signal (i.e., oscillation signal, of which the phase has been shifted) thus received to output an oscillation signal that has been amplified. That is to say, the phase of the oscillation signal input to and output from the amplifier 211a and the phase of the oscillation signal input to and output from the amplifier 211b are different. Meanwhile, the magnitude of shift caused by the second phase shifter 22 to the phase of the oscillation signal is equal to the magnitude of shift caused by the third phase shifter 23 to the phase of the oscillation signal. Therefore, the phase of the oscillation signal output by the amplifier 211b matches the phase of the oscillation signal that has been shifted by the third phase shifter 23.

The oscillator 20A outputs, to the first phase shifter 40, an oscillation signal generated by combining together the oscillation signal amplified by the amplifier 211a and the oscillation signal amplified by the amplifier 211b.

The phase control unit 50A controls the first phase shifter 40 to have the first phase shifter 40 change the load impedance of the oscillator 20A. More specifically, the phase control unit 50A controls the first phase shifter 40 to make the first phase shifter 40 change, according to the oscillating frequency of the oscillation signal, the load impedance of the oscillator 20A. For example, the phase control unit 50A controls the first phase shifter 40 to make the first phase shifter 40 shift the phase of the oscillation signal according to the frequency of the oscillation signal detected by the frequency detection unit 30A. The phase control unit 50A makes the first phase shifter 40 modulate, based on the frequency detected by the frequency detection unit 30A, the frequency of the oscillation signal. The impedance characteristics of the antenna 100 as viewed form the oscillator 20A varies according to the frequency of a microwave radiated. The phase control unit 50A makes the first phase shifter 40 modulate, based on the frequency detected by the frequency detection unit 30A, the frequency of the oscillation signal to allow the impedance of the antenna 100 to fall within an appropriate range. That is to say, the phase control unit 50A controls the first phase shifter 40 to make the first phase shifter 40 change, based on the frequency detected by the frequency detection unit 30A, the load impedance of the antenna 100 as viewed from the oscillator 20A to allow the impedance of the antenna 100 to fall within the appropriate range.

The plurality of temperature sensors 60 respectively detect the temperatures of the plurality of amplifiers 211. The plurality of temperature sensors 60 are associated one to one with the plurality of amplifiers 211, and each detect the temperature of an associated one of the plurality of amplifiers 211. Each of the plurality of temperature sensors 60 outputs, to the temperature monitoring unit 61, the result of detection with respect to an associated one of the plurality of amplifiers 211 (i.e., the temperature of the associated one of the amplifiers 211).

The temperature monitoring unit 61 receives the result of detection from each of the plurality of temperature sensors 60. The function of generating the oscillation signal using the signal generating unit 10A is controlled based on the respective results of detection that the temperature monitoring unit 61 has received. For example, at least one of frequency control, phase control, or amplitude control of the oscillation signal is performed based on the plurality of results of detection that the temperature monitoring unit 61 has received.

Note that control of the signal generating unit 10A based on the results of detection obtained by the temperature sensors 60 may be performed by the signal output device 1A or an external device, whichever is appropriate.

Next, an exemplary operation of the signal output device 1A will be described.

The signal generating unit 10A generates an oscillation signal with a predetermined frequency to radiate a microwave with the predetermined frequency. The signal generating unit 10A generates an oscillation signal with the predetermined frequency to perform, for example, gain adjustment on the oscillation signal thus generated. In this case, the frequency detection unit 30A detects the frequency of the oscillation signal thus generated.

The oscillator 20A (i.e., the power amplifier 200) makes the device group 201 and the last-stage device 202 amplify the oscillation signal. In this case, the last-stage device 202 makes the plurality of amplifiers 211 pass oscillation signals having mutually different phases. Then, the last-stage device 202 combines together the oscillation signals that have respectively passed through the plurality of amplifiers 211.

The phase control unit 50A makes the first phase shifter 40 modulate, based on the frequency detected by the frequency detection unit 30A, the frequency of the oscillation signal to allow the impedance of the antenna 100 to fall within an appropriate range. The first phase shifter 40 changes, under the control of the phase control unit 50A, the load impedance of the antenna 100 as viewed from the oscillator 20A.

The oscillation signal, of which the phase has been shifted by the first phase shifter 40, is radiated, inside the storage container 3, as a microwave from the antenna 100.

Also, the antenna 100 receives a reflected wave of the microwave radiated. The reflected wave is received and a reflection signal representing the reflected wave thus received is supplied to each of the plurality of amplifiers 211 of the last-stage device 202. This causes an increase in the temperature of each of the plurality of amplifiers 211. Thus, each of the plurality of temperature sensors 60 detects the temperature of an associated one of the plurality of amplifiers 211, and the temperature monitoring unit 61 monitors the result thus obtained.

Even if there are no reflected waves, each of the plurality of temperature sensors 60 also detects the temperature of an associated one of the plurality of amplifiers 211 in a situation where the temperature of the signal output device 1A has increased due to, for example, a decline in the cooling performance of a cooling mechanism of the signal output device 1A. The temperature monitoring unit 61 monitors the result thus obtained.

The function of generating the oscillation signal using the signal generating unit 10A is controlled based on the temperatures of the plurality of amplifiers 211 monitored by the temperature monitoring unit 61, i.e., the results of detection (i.e., the detected temperatures) obtained by the temperature sensors 60.

The signal output device 1A according to the second embodiment allows for, as in the first embodiment, radiating an appropriate microwave according to the frequency of the oscillation signal. Therefore, this configuration contributes to improving the performance even when eatables and drinkables are irradiated with a microwave.

The signal output device 1A also makes the plurality of amplifiers 211 pass such oscillation signals having mutually different phases, thus allowing for broadening the range of the impedance of the load characteristics corresponding to the frequency and the range of the impedance of the load characteristics corresponding to the output power.

Note that in the second embodiment, the oscillator 20A (i.e., the power amplifier 200) may also include a matching circuit, provided between the signal generating unit 10A and the device group 201, for matching the impedance between the signal generating unit 10A and the device group 201. Alternatively, the oscillator 20A (i.e., the power amplifier 200) may also include a matching circuit, provided between the device group 201 and the last-stage device 202, for matching the impedance between the device group 201 and the last-stage device 202. Still alternatively, the oscillator 20A (i.e., the power amplifier 200) may also include a matching circuit, provided between the first phase shifter 40 and the output terminal 70, for matching the impedance between the first phase shifter 40 and a constituent element (such as the output terminal 70 and the antenna 100) connected thereto on a stage following the output terminal 70.

Also, in the second embodiment, the oscillator 20A has a configuration in which the two amplifiers 211 are made to pass oscillation signals having mutually different phases. However, this should not be construed as limiting. Alternatively, the oscillator 20A may also make at least two out of three or more amplifiers 211 pass oscillation signals having mutually different phases. The oscillator 20A may also has a configuration in which the distributor 25 for distributing the oscillation signal to the plurality of amplifiers 211 is in charge of a part or all of the magnitude of phase shift to be caused by the second phase shifter 22. Furthermore, the oscillator 20A may also have a configuration in which the combiner 26A for combining together the output signals of the plurality of amplifiers 211 is in charge of a part or all of the magnitude of phase shift to be caused by the third phase shifter 23.

Also, the first and second variations of the first embodiment may also be applied to the second embodiment.

### Recapitulation

As can be seen from the foregoing description, a signal output device (1; 1A) according to a first aspect outputs an oscillation signal for generating a microwave to irradiate eatables and drinkables. The signal output device (1; 1A) includes an oscillator (20; 20A), a phase shifter (e.g., a first phase shifter 40), and a phase control unit (50; 50A). The oscillator (20; 20A) outputs the oscillation signal to an antenna (100) that radiates the microwave. The phase shifter is provided at a destination of the oscillator (20; 20A) to change load impedance of the antenna (100) as viewed from the oscillator (20; 20A). The phase control unit (50; 50A) controls the phase shifter to make the phase shifter change, according to an oscillating frequency of the oscillation signal, the load impedance of the oscillator (20; 20A).

This aspect allows for radiating an appropriate microwave according to the frequency of the oscillation signal. Therefore, this aspect contributes to improving the performance even when eatables and drinkables are irradiated with a microwave.

In a signal output device (1A) according to a second aspect, which may be implemented in conjunction with the first aspect, the oscillator (20A) includes a power amplifier (200). The power amplifier (200) includes a last-stage device (202) including a plurality of amplifiers (211) connected in parallel. The power amplifier (200) makes the plurality of amplifiers (211) pass a plurality of the oscillation signals having mutually different phases and combines together the plurality of the oscillation signals that have respectively passed through the plurality of amplifiers (211).

This aspect allows for broadening the range of the impedance of the load characteristics corresponding to the frequency available and the range of the impedance of the load characteristics corresponding to the output power available.

In a signal output device (1) according to a third aspect, which may be implemented in conjunction with the first aspect, the oscillator (20) includes a plurality of amplifiers (21) connected in parallel and a feedback control unit (24). The feedback control unit (24) outputs a feedback signal to the plurality of amplifiers (21) by performing feedback control on the plurality of amplifiers (21). The oscillator (20) makes the plurality of amplifiers (21) pass a plurality of the feedback signals having mutually different phases and combines together the plurality of the feedback signals that have respectively passed through the plurality of amplifiers (21) and thereby generates the oscillation signal.

This aspect allows for broadening the range of the impedance of the load characteristics corresponding to the frequency available and the range of the impedance of the load characteristics corresponding to the output power available.

A signal output device (1; 1A) according to a fourth aspect, which may be implemented in conjunction with the first aspect, further includes a temperature sensor (60). The oscillator (20; 20A) includes an amplifier (21; 211). The temperature sensor (60) detects a temperature of the amplifier (21; 211).

According to this aspect, monitoring the temperature of the amplifier (21; 211) allows for more accurately controlling the microwave to radiate, i.e., the output of the oscillation signal.

A signal output device (1; 1A) according to a fifth aspect, which may be implemented in conjunction with the second or third aspect, further includes a plurality of temperature sensors (60) for respectively detecting temperatures of the plurality of amplifiers (21; 211).

According to this aspect, monitoring the temperature of the plurality of amplifiers (21; 211) allows for more accurately controlling the microwave to radiate, i.e., the output of the oscillation signal.

A signal output device (1; 1A) according to a sixth aspect, which may be implemented in conjunction with any one of the first to fifth aspects, further includes a frequency detection unit (30; 30A). The frequency detection unit (30; 30A) detects a frequency of the oscillation signal output by the oscillator (20; 20A). The phase control unit (50; 50A) controls the phase shifter to make the phase shifter shift a phase of the oscillation signal according to the frequency detected by the frequency detection unit (30; 30A).

This aspect allows for radiating an appropriate microwave according to the frequency of the oscillation signal.

A microwave oven (2a) according to a seventh aspect includes the signal output device (1; 1A) according to any one of the first to six aspects and a storage container (3). The storage container (3) stores an object serving as a target to be irradiated with the microwave that is radiated from the signal output device (1; 1A) via the antenna (100).

This aspect contributes to improving the performance even when eatables and drinkables are irradiated with a microwave.

A refrigerator according to an eighth aspect includes the signal output device (1; 1A) according to any one of the first to six aspects and a storage container (3). The storage container (3) stores an object serving as a target to be irradiated with the microwave that is radiated from the signal output device (1; 1A) via the antenna (100).

This aspect contributes to improving the performance even when eatables and drinkables are irradiated with a microwave.

A freezer according to a ninth aspect includes the signal output device (1; 1A) according to any one of the first to six aspects and a storage container (3). The storage container (3) stores an object serving as a target to be irradiated with the microwave that is radiated from the signal output device (1; 1A) via the antenna (100).

This aspect contributes to improving the performance even when eatables and drinkables are irradiated with a microwave.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A signal output device configured to output an oscillation signal for generating a microwave to irradiate eatables and drinkables, the signal output device comprising:
an oscillator configured to output the oscillation signal to an antenna, the antenna being configured to radiate the microwave;
a phase shifter provided at a destination of the oscillator to change load impedance of the antenna as viewed from the oscillator; and
a phase control unit configured to control the phase shifter to make the phase shifter change, according to an oscillating frequency of the oscillation signal, the load impedance of the oscillator.

2. The signal output device of claim 1, wherein
the oscillator includes a power amplifier,
the power amplifier includes a last-stage device including a plurality of amplifiers connected in parallel, and
the power amplifier is configured to make the plurality of amplifiers pass a plurality of the oscillation signals having mutually different phases and to combine together the plurality of the oscillation signals that have respectively passed through the plurality of amplifiers.

3. The signal output device of claim 1, wherein
the oscillator includes:
a plurality of amplifiers connected in parallel; and
a feedback control unit configured to output a feedback signal to the plurality of amplifiers by performing feedback control on the plurality of amplifiers, and
the oscillator is configured to make the plurality of amplifiers pass a plurality of the feedback signals having mutually different phases and to combine together the plurality of the feedback signals that have respectively passed through the plurality of amplifiers and thereby generate the oscillation signal.

4. The signal output device of claim 1, further comprising a temperature sensor, wherein
the oscillator includes an amplifier, and
the temperature sensor is configured to detect a temperature of the amplifier.

5. The signal output device of claim 2, further comprising a plurality of temperature sensors configured to respectively detect temperatures of the plurality of amplifiers.

6. The signal output device of claim 1, further comprising a frequency detection unit configured to detect a frequency of the oscillation signal output by the oscillator, wherein
the phase control unit is configured to control the phase shifter to make the phase shifter shift a phase of the oscillation signal according to the frequency detected by the frequency detection unit.

7. A microwave oven comprising:
the signal output device according to claim 1; and
a storage container configured to store an object serving as a target to be irradiated with the microwave that is radiated from the signal output device via the antenna.

8. A refrigerator comprising:
the signal output device according to claim 1; and
a storage container configured to store an object serving as a target to be irradiated with the microwave that is radiated from the signal output device via the antenna.

9. A freezer comprising:
the signal output device according to claim 1; and
a storage container configured to store an object serving as a target to be irradiated with the microwave that is radiated from the signal output device via the antenna.
